(19) United States
(12) Patent Application Publication
(10) Pub. No.: US 2025/0024234 A1
(43) Pub. Date: Jan. 16, 2025

(54) WIRELESS COMMUNICATION METHOD AND DEVICE THEREOF

(71) Applicant: ZTE CORPORATION, Shenzhen, Guangdong (CN)

(72) Inventors: Yuze LIU, Shenzhen (CN); Shilin YOU, Shenzhen (CN); Zhen XING, Shenzhen (CN); Zhaoji LIN, Shenzhen (CN)

(73) Assignee: ZTE CORPORATION, Shenzhen, Guangdong (CN)

(21) Appl. No.: 18/899,083

(22) Filed: Sep. 27, 2024

Related U.S. Application Data
(63) Continuation of application No. PCT/CN2022/105017, filed on Jul. 11, 2022.

(51) Int. Cl. H04W 4/50; H04L 67/51; H04W 8/20

(52) U.S. Cl. CPC H04W 4/50; H04L 67/51; H04W 8/20

(57) ABSTRACT

A wireless communication method for use in a first wireless device is disclosed. The method comprises receiving, from a second wireless device, update information of proximity service (ProSe) subscription data of at least one wireless terminal.

### CROSS-REFERENCE TO RELATED APPLICATION

This application claims the benefit of priority under 35 U.S.C. § 120 as a continuation of International Patent Application No. PCT/CN2022/105017, filed on Jul. 11, 2022, the disclosure of which is incorporated herein by reference in its entirety.

### TECHNICAL FIELD

This document is directed generally to wireless communications, and in particular to proximity service (ProSe) communications.

### BACKGROUND

A 3GPP system may need to be able to authorize a user equipment (UE) to access a 5G core network (5GC) via a 5G UE-to-Network Relay and to authorize a UE to perform as a UE-to-Network Relay. Without a proper authorization, unauthorized entities will be able to access the 5GC via the UE-to-Network Relay or act as the UE-to-Network Relays, creating a vulnerability and causing possible (D) DOS ((distributed) denial of service) attacks or leading to unauthorized service usage on both a 5G system (5GS) and the UE-to-Network Relay.

### SUMMARY

According to the specification related to a user plane solution, for the ProSe UE-to-Network Relay, if authorization information of the 5G ProSe UE-to-Network Relay is not locally available, the 5G ProSe key management function (PKMF) requests the authorization information from a unified data management (UDM). For the 5G ProSe Remote UE, if authorization information of the 5G ProSe Remote UE is not locally available, the 5G PKMF requests the authorization information from the UDM of the 5G ProSe Remote UE.

According to the specification related to a control plane solution, a relay access and mobility management function (AMF) should authorize the Relay UE. For the remote UE, an authentication server function (AUSF) gets the authorization information from the UDM and stores the authentication in a ProSe anchor function (PAnF).

However, subscription information/data in the UDM may be changed. For example, the service may become unavailable for a UE. If the changed information/data is not distributed to the PKMF, the AMF, the PAnF, etc., the UE can still use the unavailable service, resulting in a bad impact on charging and a waste of network resources.

This document relates to methods, systems, and devices for subscription information synchronization, and in particular to methods, systems, and devices for subscription information in proximity based services.

One aspect of the present disclosure relates to a wireless communication method for use in a first wireless device, the method comprising: receiving, from a second wireless device, update information of proximity service, ProSe, subscription data of at least one wireless terminal.

Another aspect of the present disclosure relates to a wireless communication method for use in a second wireless device, the method comprising: transmitting, to a first wireless device, update information of proximity service, ProSe, subscription data of at least one wireless terminal.

Another aspect of the present disclosure relates to a first wireless device, comprising: a communication unit, configured to receive, from a second wireless device, update information of proximity service, ProSe, subscription data of at least one wireless terminal.

Another aspect of the present disclosure relates to a second wireless device, comprising: a communication unit, configured to transmit, to a first wireless device, update information of proximity service, ProSe, subscription data of at least one wireless terminal.

Various embodiments may preferably implement the following features:

Preferably or in some embodiments, the update information comprises at least one of:
an identity of each wireless terminal, or a ProSe subscription update indication for each wireless terminal.

Preferably or in some embodiments, the ProSe subscription update indication indicates at least one of: whether an access via a relay wireless terminal is available, a list of public land mobile networks, PLMNs, authorized for ProSe, or whether a service code associated with a ProSe is available.

Preferably or in some embodiments, the method further comprises: transmitting, to the second wireless device, a subscription message for the update information.

Preferably or in some embodiments, the subscription message comprises at least one of: an identity of each wireless terminal, a service code associated with a ProSe, an identity of the first wireless device, or a serving network name.

Preferably or in some embodiments, the service code indicates at least one of: a connectivity service provided from a wireless terminal to another wireless terminal, or an authorization identification of the ProSe for each wireless terminal.

Preferably or in some embodiments, the authorization identification relates to at least one policy of the PorSe for each wireless terminal.

Preferably or in some embodiments, the subscription message for the update information is transmitted, by the first wireless device, no earlier than at least one of: receiving, from an authentication service function, AUSF, a request associated with a ProSe key registration for the at least one wireless terminal, transmitting, to the AUSF, a response associated with the ProSe key registration for the at least one wireless terminal, transmitting, to the second wireless device, a request for the ProSe subscription data of at least one wireless terminal, receiving, from the second wireless device, the ProSe subscription data of at least one wireless terminal, storing the ProSe subscription data of at least one wireless terminal, receiving, from the AUSF, a request associated with a ProSe key for the at least one wireless terminal, transmitting, to the AUSF, a response associated with a ProSe key for the at least one wireless terminal, transmitting, to the second wireless device, a request for authorization information of providing a ProSe corresponding to the ProSe key to the at least one wireless terminal, receiving, from the second wireless device, the authorization information of providing the ProSe corresponding to the ProSe key to the at least one wireless terminal, or storing the authorization information of providing the ProSe corresponding to the ProSe key to the at least one wireless terminal.

Preferably or in some embodiments, the subscription message for the update information is transmitted, by the first wireless device, no earlier than at least one of: checking authorization information of providing a ProSe to the at least one wireless terminal, transmitting, to the second wireless device, a request for the authorization information of providing the ProSe to the at least one wireless terminal, or receiving, from the second wireless device, a response for the authorization information of providing the ProSe to the at least one wireless terminal.

Preferably or in some embodiments, the updated information is received in an update request.

Preferably or in some embodiments, the method further comprises: transmitting, to the second wireless device, a response in response to the update request.

Preferably or in some embodiments, the first wireless device comprises at least one of a ProSe anchor function or a ProSe key management function.

Preferably or in some embodiments, the second wireless device comprises at least one of a unified data management, a unified data repository, a policy control function or a ProSe application function.

Preferably or in some embodiments, the method further comprises: receiving, from the first wireless device, a subscription message for the update information.

Preferably or in some embodiments, the subscription message is received, by the second wireless device, no earlier than at least one of: receiving, from the first wireless device, a request for the ProSe subscription data of at least one wireless terminal, transmitting, to the first wireless device, the ProSe subscription data of at least one wireless terminal, receiving, from the first wireless device, a request for authorization information of providing a ProSe corresponding to the ProSe key to the at least one wireless terminal, or transmitting, to the first wireless device, the authorization information of providing the ProSe corresponding to the ProSe key to the at least one wireless terminal.

Preferably or in some embodiments, the subscription message is received, by the second wireless device, no earlier than at least one of: receiving, from the first wireless device, a request for the authorization information of providing the ProSe to the at least one wireless terminal, or transmitting, to the first wireless device, a response for the authorization information of providing the ProSe to the at least one wireless terminal.

Preferably or in some embodiments, the method further comprises: receiving, from the first wireless device, a response in response to the update request.

Preferably or in some embodiments, the first wireless device further comprises a processor configured to perform the wireless communication method described above.

Preferably or in some embodiments, the second wireless device further comprises a processor configured to perform the wireless communication method described above.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a network according to an embodiment of the present disclosure.

FIG. 2 shows an architecture according to an embodiment of the present disclosure.

FIG. 3 shows a security procedure over control plane according to an embodiment of the present disclosure.

FIG. 4 shows an example of a schematic diagram of a wireless terminal according to an embodiment of the present disclosure.

FIG. 5 shows an example of a schematic diagram of a wireless network node according to an embodiment of the present disclosure.

FIG. 6 shows an example of the NF consumer of ProSe subscription data Subscribe to the NF provider of ProSe subscription data according to an embodiment of the present disclosure.

FIG. 7 shows an example of the NF provider of ProSe subscription data request the NF consumer of ProSe subscription data to update according to an embodiment of the present disclosure.

FIG. 8 shows an example of a PAnF act as the NF consumer according to an embodiment of the present disclosure.

FIG. 9 shows an example of a PKMF act as the NF consumer according to an embodiment of the present disclosure.

FIG. 10 shows a flowchart of a method according to an embodiment of the present disclosure.

FIG. 11 shows a flowchart of a method according to an embodiment of the present disclosure.

### DETAILED DESCRIPTION

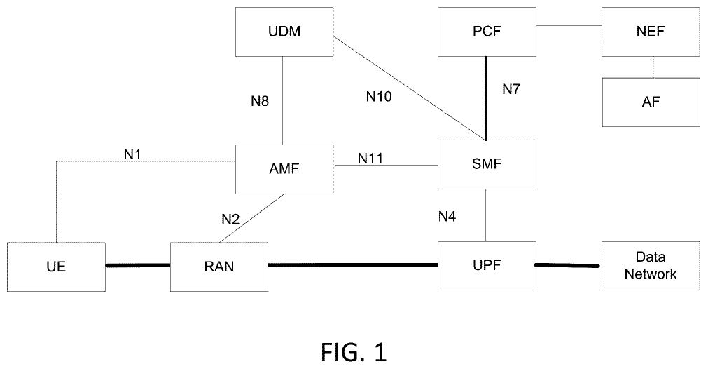

FIG. 1 shows a schematic diagram of a network (architecture) according to an embodiment of the present disclosure. In FIG. 1, the network comprises the following network functions/entities:
1) UE: User Equipment
2) RAN: Radio Access Network

In the present disclosure, the RAN may be equal to RAN node or next-generation RAN (NG-RAN) (node).
3) AMF: Access and Mobility Management Function

The AMF includes the following functionalities: Registration Management, Connection Management, Reachability Management and Mobility Management. The AMF terminates the RAN Control Plane (CP) interface N2 and NAS interface N1, non-access stratum (NAS) ciphering and integrity protection. It also distributes the session management (SM) NAS to proper session management functions (SMFs) via interface N11. The AMF provides services for other consumer Network Functions (NFs) to subscribe or get notified of the mobility related events and information.
4) SMF: Session Management Function

The SMF includes the following functionalities: session establishment, modification and release, UE IP address allocation & management (including optional authorization functions), selection and control of User Plane (UP) function, downlink data notification. The SMF can subscribe the mobility related events and information from the AMF.
5) UPF: User Plane Function

The UPF includes the following functionalities: serving as an anchor point for intra-/inter-radio access technology (RAT) mobility and the external session point of interconnect to a Data Network, packet routing & forwarding as indicated by SMF, traffic usage reporting, quality of service (QOS) handling for the UP, downlink packet buffering and downlink data notification triggering, etc.
6) UDM: Unified Data Management

The UDM manages the subscription profile for the UEs. The subscription includes the data used for mobility management (e.g. restricted area), session management (e.g. QoS profile per slice per DNN). The subscription data also includes the slice selection parameters which are used by the AMF to select a proper SMF. The AMF and SMF get the subscription from UDM. The subscription data is stored in the Unified Data Repository (UDR). The UDM uses such data upon reception of a request from the AMF or the SMF.
7) PCF: Policy Control Function

The PCF supports unified policy framework to govern network behavior. The PCF provides an access management policy to the AMF, or session management policy to the SMF, and/or UE policy to the UE. The PCF can access the UDR to obtain subscription information relevant for policy decisions. The PCF may also generate the policy to govern network behavior based on the subscription and an indication from an application function (AF). Then, the PCF can provide policy rules to CP functions (e.g. the AMF and/or the SMF) to enforce the CP functions.
8) NEF: Network Exposure Function

The NEF supports exposure of capability and events of the network towards the AF. A third party AF can invoke the service provided by the network via the NEF and the NEF performs authentication and authorization of the third party applications. The NEF also provides translation of the information exchanged with the AF and information exchanged with the internal NF.
9) AF: Application Function

The AF interacts with the Core Network in order to provide services, e.g. to support: application influence on traffic routing, accessing the NEF, interacting with the Policy framework for policy control etc. The AF that is considered to be trusted by the operator can be allowed to interact directly with relevant NFs. The AF not allowed by the operator to access directly the NFs has to use the external exposure framework via the NEF to interact with relevant NFs. The AF may store the application information in the UDR via the NEF.

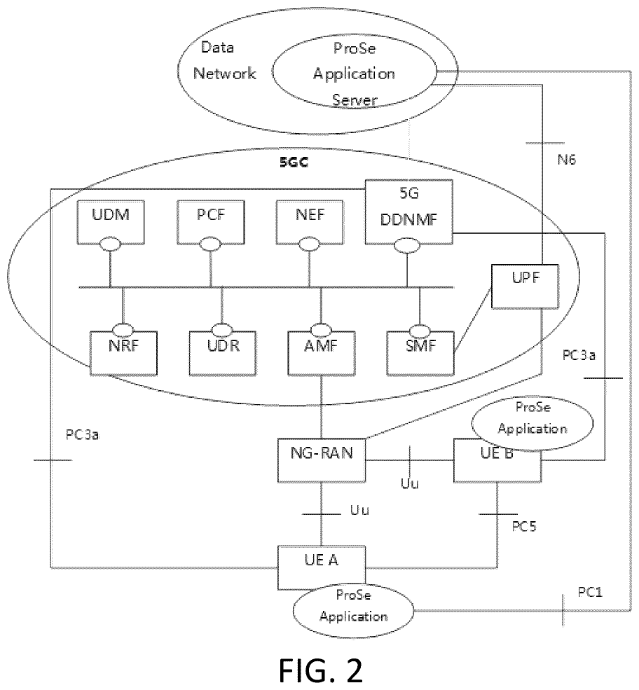

FIG. 2 relates to an (network) architecture according to an embodiment of the present disclosure. In the architecture, a 5G Direct Discovery Name Management Function (DDNMF) is introduced into the 5GC as a new network function. The 5G DDNMF has similar functions from an architecture point of view to the DDNMF part of ProSe Function.

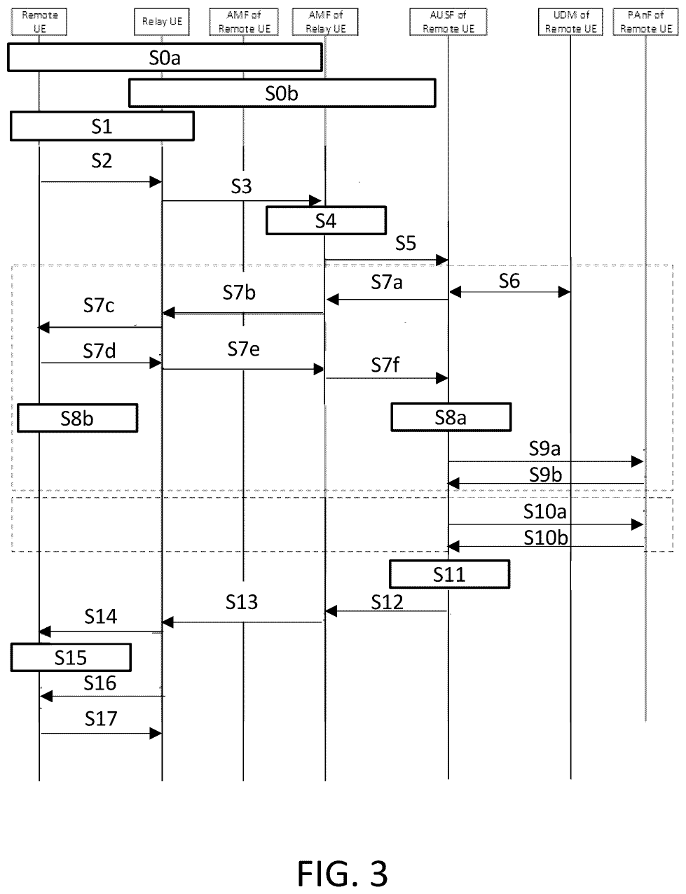

FIG. 3 relates to a security procedure over the control plane according to an embodiment of the present disclosure. The procedure has the following steps:

Steps S0a+S0b: the 5G ProSe Remote UE and the 5G ProSe UE-to-Network Relay are registered with the network. The 5G ProSe UE-to-Network Relay is authenticated and authorized by the network to provide a UE-to-Network Relay service. The 5G ProSe Remote UE is authenticated and authorized by the network to receive the UE-to-Network Relay service. PC5 security policies are provisioned to the 5G ProSe Remote UE and the 5G ProSe UE-to-Network Relay respectively during this authorization and information provisioning procedure.

Step S1: the 5G ProSe Remote UE initiates a procedure for Model A 5G ProSe Direct Discovery and/or a procedure for Model B 5G ProSe Direct Discovery. The procedure for Model A 5G ProSe Direct Discovery is applied for open and restricted 5G ProSe Direct Discovery when the ProSe enabled UE is served by the NG-RAN. The procedure for Model B 5G ProSe Direct Discovery is applied for restricted 5G ProSe Direct Discovery when the ProSe enabled UE is served by the NG-RAN.

Step S2: after the discovery of the 5G ProSe UE-to-Network Relay, the 5G ProSe Remote UE sends a Direct Communication Request to the 5G ProSe UE-to-Network Relay for establishing secure PC5 unicast link. The 5G ProSe Remote UE includes its security capabilities and PC5 signaling security policy in a Dynamic Channel Reservation (DCR) message. The message also includes Relay Service Code, Nonce_1.

If the 5G ProSe Remote UE does not have a valid 5G ProSe Remote User Key (5GPRUK), the 5G ProSe Remote UE includes a Subscriber Concealed Identifier (SUCI) in the DCR to trigger 5G ProSe Remote UE specific authentication and establish a 5GPRUK.

If the 5G ProSe Remote UE already has a valid 5GPRUK, the 5G ProSe Remote UE includes the 5GPRUK ID in the DCR to indicate that the 5G ProSe Remote UE wants to get relay connectivity using the 5GPRUK.

Step S3: upon receiving the DCR message, the 5G ProSe UE-to-Network Relay sends the Relay Key Request to the AMF of the 5G ProSe UE-to-Network Relay, including SUCI or 5GPRUK ID, RSC and Nonce_1 received in the DCR message. The 5G ProSe UE-to-Network Relay also includes in the message a transaction identifier that identifies the 5G ProSe Remote UE for the subsequent messages over NAS messages of the 5G ProSe UE-to-Network Relay.

Step S4: the AMF of the 5G ProSe UE-to-Network Relay verifies whether the 5G ProSe UE-to-Network Relay is authorized to provide the UE-to-Network Relay service.

Step S5: the AMF of the 5G ProSe UE-to-Network Relay selects an AUSF based on SUCI or 5GPRUK ID and forward the parameters received in Relay Key Request to the AUSF in Nausf_UEAuthentication_ProseAuthenticate Request message. The Nausf_UEAuthentication ProseAuthenticate Request message contains the SUCI of the 5G ProSe Remote UE or 5GPRUK ID, Relay Service Code, Nonce_1. If a 5GPRUK ID is received from the AMF of the 5G ProSe UE-to-Network Relay, the AUSF of the 5G ProSe Remote UE skips steps S6-S9. If the SUCI of the 5G ProSe Remote UE is received from the AMF of the 5G ProSe UE-to-Network Relay, the AUSF of the 5G ProSe Remote UE skips S10.

Step S6: the AUSF initiates a 5G ProSe Remote UE specific authentication using the ProSe specific parameters received (i.e., RSC, etc.).

The AUSF of the 5G ProSe Remote UE retrieves the Authentication Vectors and the Routing Indicator of the 5G ProSe Remote UE from the UDM via Nudm_UEAuthentication_GetProseAv Request message. Upon reception of the Nudm_UEAuthentication_GetProSeAv Request, the UDM invokes SIDF de-conceal SUCI to gain a Subscription Permanent Identifier (SUPI) before UDM can process the request. The UDM checks whether the UE is authorized to use a ProSe UE-to-Network Relay service based on authorization information in Subscription data of the UE. If the UE is authorized, the UDM chooses the authentication method based on the SUPI.

Step S7a: if EAP-AKA′ is selected by UDM, the AUSF of the 5G ProSe Remote UE triggers authentication of the 5G ProSe Remote UE based on EAP-AKA′. The AUSF of the 5G ProSe Remote UE generates the EAP-Request/AKA′-Challenge message and send EAP-Request/AKA′-Challenge message to the AMF of the 5G ProSe UE-to-Network Relay in a Nausf_UEAuthentication_ProSeAuthenticate Response message.

Step S7b: the AMF of the 5G ProSe UE-to-Network Relay forwards the Relay Authentication Request (including the EAP-Request/AKA′-Challenge) to the 5G ProSe UE-to-Network Relay over a NAS message, including a transaction identifier of the 5G ProSe Remote UE in the message. The NAS message is protected using the NAS security context created for the 5G ProSe UE-to-Network Relay.

Step S7c: Based on the transaction identifier, the 5G ProSe UE-to-Network Relay forwards the EAP-Request/AKA′-Challenge to the 5G ProSe Remote UE over PC5 messages.

The USIM in the 5G ProSe Remote UE verifies the validity of the received values by checking whether the AUTN can be accepted.

For EAP-AKA′, the USIM computes a response RES. The USIM returns RES, CK, IK to the ME. The ME derives CK′ and IK′.

Step S7d: the 5G ProSe Remote UE returns the EAP-Response/AKA′-Challenge to the 5G ProSe UE-to-Network Relay over PC5 messages.

Step S7e: the 5G ProSe UE-to-Network Relay forwards the EAP-Response/AKA′-Challenge together with the transaction identifier of the 5G ProSe Remote UE to the AMF of the 5G ProSe UE-to-Network Relay in a NAS message Relay Authentication Response.

Step S7f: the AMF of the 5G ProSe UE-to-Network Relay forwards EAP-Response/AKA′-Challenge to the AUSF of the 5G ProSe Remote UE via a Nausf_UEAuthentication_ProSeAuthenticate Request.

The AUSF of the 5G ProSe Remote UE performs the UE authentication by verifying the received information.

For EAP-AKA′, the AUSF of the 5G ProSe Remote UE and the 5G ProSe Remote UE may exchange EAP-Request/AKA′-Notification and EAP-Response/AKA′-Notification messages via the AMF of the 5G ProSe UE-to-Network Relay and the 5G ProSe UE-to-Network Relay. After the exchanges, the AUSF of the 5G ProSe Remote UE and the 5G ProSe Remote UE derives the K_{AUSF_P} in the same way as K_{AUSF} is derived.

Step S8: on successful authentication, the AUSF of the 5G ProSe Remote UE and the 5G ProSe Remote UE generates 5GPRUK and 5GPRUK ID.

The 5GPRUK ID is in a network access identifier (NAI) format, i.e. username@realm. The username part includes the Routing Indicator from step 6 and the 5GPRUK ID*, and the realm part includes Home Network Identifier.

Step S9a: the AUSF of the 5G ProSe Remote UE selects the PAnF (ProSe Anchor Function) based on 5GPRUK ID and send the SUPI, RSC, 5GPRUK and 5GPRUK ID in Npanf_ProseKey_Register Request message to the PAnF.

Step S9b: the PAnF stores the ProSe context info (i.e., SUPI, RSC, 5GPRUK, 5GPRUK ID) for the 5G ProSe Remote UE and send Npanf_ProseKey_Register Response message to the AUSF.

Step S10a: the AUSF of the 5G ProSe Remote UE selects the PAnF based on 5GPRUK ID and send received 5GPRUK ID and RSC in Npanf_ProseKey_get Request message.

Step S10b: the PAnF retrieves the 5GPRUK based on the 5GPRUK ID and checks whether the 5G ProSe Remote UE is authorized to use the UE-to-Network Relay service based on received RSC. If the 5G ProSe Remote UE is authorized and the retrieved 5GPRUK is valid. the PAnF sends Npanf_ProseKey_get Response message with 5GPRUK to the AUSF.

Step S11: the AUSF of the 5G ProSe Remote UE generates Nonce_2 and derives the K_{NR_ProSe} key using 5GPRUK, Nonce_1 and Nonce_2 as defined in Annex A.4.

Step S12: the AUSF of the 5G ProSe Remote UE sends the K_{NR_ProSe}, Nonce_2 in Nausf_UEAuthentication_ProseAuthenticate Response message to the 5G ProSe UE-to-Network Relay via the AMF of the 5G ProSe UE-to-Network Relay. An EAP Success message is included if step S7 is performed successfully. The AUSF of the 5G ProSe Remote UE also includes the 5GPRUK ID in the message if generated in step S8.

Step S13: when receiving a K_{NR_ProSe} from the AUSF of the 5G ProSe Remote UE via the AMF of the 5G ProSe UE-to-Network Relay, the 5G ProSe UE-to-Network Relay derives the PC5 session key K_{relay-sess}, the confidentiality key K_{relay-enc} (if applicable) and the integrity key K_{relay-int} from the K_{NR_ProSe}. K_{NR_ProSe} ID and K_{relay-sess} ID are established in the same way as K_{NRP} ID and K_{NRP-sess} ID. The EAP Success message and 5GPRUK ID are also sent from the AMF of the 5G ProSe UE-to-Network Relay to UE-to-Network Relay if received from AUSF.

Step S14: the 5G ProSe UE-to-Network Relay sends the received Nonce_2 and PC5 signaling security policy of the 5G ProSe Remote UE to the 5G ProSe Remote UE in a Direct Security mode command message, which is integrity protected using K_{relay-int}. An EAP Success message is included if received from the AMF of the 5G ProSe UE-to-Network Relay.

Step S15: the 5G ProSe Remote UE generates the K_{NR_ProSe} key to be used for remote access via the 5G ProSe UE-to-Network Relay in the same way as defined in step S11. The 5G ProSe Remote UE derives PC5 session key K_{relay-sess} and confidentiality and integrity keys from K_{NR_ProSe} in the same way as defined in step S13.

Step S16: the 5G ProSe Remote UE sends the Direct Security Mode Complete message containing its PC5 user plane security policies to the 5G ProSe UE-to-Network relay, which is protected by K_{relay-int} or/and K_{relay-enc} derived from K_{relay-sess} according to the negotiated PC5 signaling policies between the 5G ProSe Remote UE and the 5G ProSe UE-to-Network Relay.

Step S17: after the successful verification of the Direct Security Mode complete message, the 5G ProSe UE-to-Network Relay responds a Direct Communication Accept message to the 5G ProSe Remote UE to finish the PC5 connection establishment procedures and store the 5GPRUK ID in the security context associated to the PC5 link with the 5G ProSe Remote UE.

Further communication between the 5G ProSe Remote UE and the Network takes place securely via the 5G ProSe UE-to-Network Relay.

The following subscription information is defined for 5G ProSe:
subscription for open 5G ProSe Direct Discovery for NR PC5:
open 5G ProSe Direct Discovery Model A.
subscription for restricted 5G ProSe Direct Discovery for NR PC5:
restricted 5G ProSe Direct Discovery Model A;
restricted 5G ProSe Direct Discovery Model A with application-controlled extension;
restricted 5G ProSe Direct Discovery Model A with “on demand” announcing;
restricted 5G ProSe Direct Discovery Model B.
subscription for Broadcast, Groupcast and Unicast mode 5G ProSe Direct Communication for NR PC5.
subscription for 5G ProSe UE acting as 5G ProSe Layer-2 UE-to-Network Relay.
subscription for 5G ProSe UE acting as 5G ProSe Layer-3 UE-to-Network Relay.
subscription for 5G ProSe Layer-2 Remote UE access via 5G ProSe Layer-2 UE-to-Network Relay.
subscription for 5G ProSe Layer-3 Remote UE access via 5G ProSe Layer-3 UE-to-Network Relay.
UE-PC5-AMBR for NR PC5.
PC5 QoS parameters used by NG-RAN.
the list of the PLMNs authorized for 5G ProSe services, including:
   the list of the PLMNs where the UE is authorized for open 5G Direct Discovery Model A, i.e. to announce or monitor or both.
   the list of the PLMNs where the UE is authorized for restricted 5G ProSe Direct Discovery Model A, i.e. to announce or monitor or both.
   the list of the PLMNs where the UE is authorized for restricted 5G ProSe Direct Discovery Model B, i.e. to perform Discoverer operation or Discoveree operation or both.
   the list of the PLMNs where the UE is authorized to perform Broadcast, Groupcast and Unicast mode 5G ProSe Direct Communication for NR PC5.
   the list of the PLMNs where the UE is authorized to act as a 5G ProSe Layer-2 UE-to-Network Relay.
   the list of the PLMNs where the UE is authorized to act as a 5G ProSe Layer-3 UE-to-Network Relay.
   the list of the PLMNs where the UE is authorized to act as a 5G ProSe Layer-2 Remote UE.

The Service Parameters for 5G ProSe UE-to-Network Relay Discovery and 5G ProSe UE-to-Network Relay Communications include:

### ProSe Relay Discovery Policy/Parameters for 5G ProSe UE-to-Network Relay:

Includes the parameters that enable the UE to perform 5G ProSe UE-to-Network Relay Discovery when provided by PCF or provisioned in the ME or configured in the UICC:
5G ProSe UE-to-Network Relay Discovery parameters (User Info ID, Relay Service Code(s), UE-to-Network Relay Layer Indicator(s)); the UE-to-Network Relay Layer Indicator indicates whether a particular RSC is offering 5G ProSe Layer-2 or Layer-3 UE-to-Network Relay service.
Default Destination Layer-2 ID(s) for sending Relay Discovery Announcement and Relay Discovery Additional Information messages and receiving Relay Discovery Solicitation messages;
For 5G ProSe Layer-3 UE-to-Network Relay, the PDU Session parameters (PDU Session type, DNN, SSC Mode, S-NSSAI, Access Type Preference) to be used for the relayed traffic for each ProSe Relay Service Code;
Includes security related content for 5G ProSe UE-to-Network Relay Discovery for each ProSe Relay Service Code.

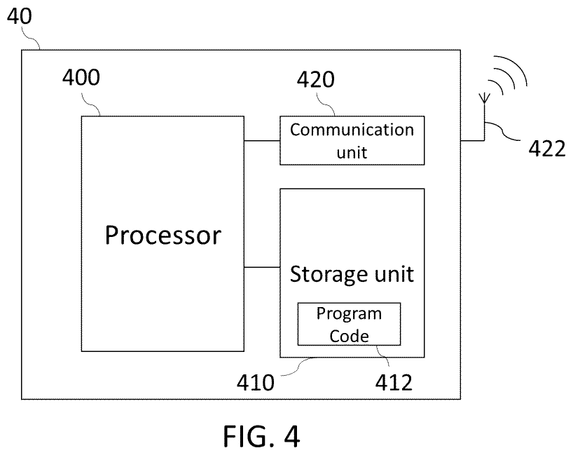

FIG. 4 relates to a schematic diagram of a wireless terminal 40 according to an embodiment of the present disclosure. The wireless terminal 40 may be a user equipment (UE), a mobile phone, a laptop, a tablet computer, an electronic book or a portable computer system and is not limited herein. The wireless terminal 40 may include a processor 400 such as a microprocessor or Application Specific Integrated Circuit (ASIC), a storage unit 410 and a communication unit 420. The storage unit 410 may be any data storage device that stores a program code 412, which is accessed and executed by the processor 400. Embodiments of the storage unit 410 include but are not limited to a subscriber identity module (SIM), read-only memory (ROM), flash memory, random-access memory (RAM), hard-disk, and optical data storage device. The communication unit 420 may a transceiver and is used to transmit and receive signals (e.g., messages or packets) according to processing results of the processor 400. In an embodiment, the communication unit 420 transmits and receives the signals via at least one antenna 422 shown in FIG. 4.

In an embodiment, the storage unit 410 and the program code 412 may be omitted and the processor 400 may include a storage unit with stored program code.

The processor 400 may implement any one of the steps in exemplified embodiments on the wireless terminal 40, e.g., by executing the program code 412.

The communication unit 420 may be a transceiver. The communication unit 420 may as an alternative or in addition be combining a transmitting unit and a receiving unit configured to transmit and to receive, respectively, signals to and from a wireless network node (e.g., a base station).

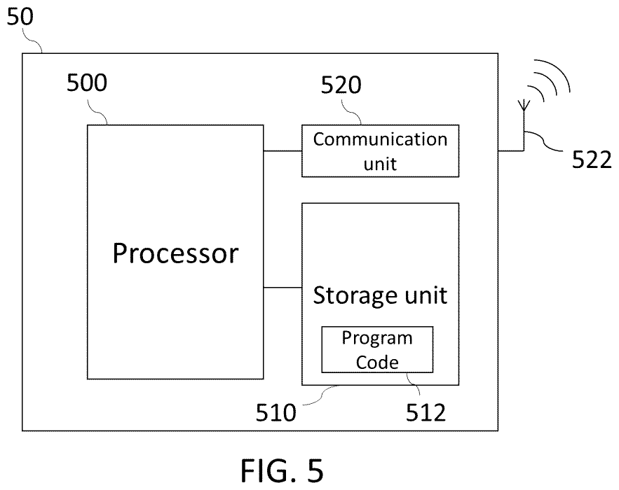

FIG. 5 relates to a schematic diagram of a wireless network node 50 according to an embodiment of the present disclosure. The wireless network node 50 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 50 may comprise (perform) at least one network function such as an access and mobility management function (AMF), a session management function (SMF), a user place function (UPF), a policy control function (PCF), an application function (AF), etc. The wireless network node 50 may include a processor 500 such as a microprocessor or ASIC, a storage unit 510 and a communication unit 520. The storage unit 510 may be any data storage device that stores a program code 512, which is accessed and executed by the processor 500. Examples of the storage unit 510 include but are not limited to a SIM, ROM, flash memory, RAM, hard-disk, and optical data storage device. The communication unit 520 may be a transceiver and is used to transmit and receive signals (e.g., messages or packets) according to processing results of the processor 500. In an example, the communication unit 520 transmits and receives the signals via at least one antenna 522 shown in FIG. 5.

In an embodiment, the storage unit 510 and the program code 512 may be omitted. The processor 500 may include a storage unit with stored program code.

The processor 500 may implement any steps described in exemplified embodiments on the wireless network node 50, e.g., via executing the program code 512.

The communication unit 520 may be a transceiver. The communication unit 520 may as an alternative or in addition be combining a transmitting unit and a receiving unit configured to transmit and to receive, respectively, signals to and from a wireless terminal (e.g., a user equipment or another wireless network node).

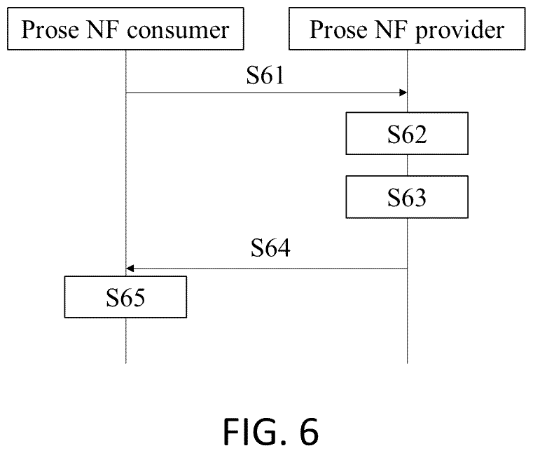

In an embodiment, there is provided an example method for a ProSe NF consumer of ProSe subscription data subscribe to a ProSe NF provider of ProSe subscription data according to an embodiment of the present disclosure as shown in FIG. 6. In the following, the ProSe NF consumer may be called NF consumer and the ProSe NF provider may be called NF provider. The method of FIG. 6 comprises the following steps:

Step S61: the NF consumer (e.g. PAnF, PKMF) of ProSe subscription data sends a ProSe subscription data subscribe message to the NF provider of ProSe subscription data (e.g. the UDM, the UDR, the PCF, the ProSe AF). The message may include the UE identity. The UE identity (e.g. SUPI) can be used to find the subscription data of the UE in the NF consumer and NF provider.

The message may include a service code. The service code is used to identify a connectivity service for one UE provide to another UE, such as the connectivity service that the 5G ProSe UE-to-Network Relay provides to a 5G ProSe Remote UE. The Relay Service Codes are configured in a 5G ProSe UE-to-Network Relay for advertisement.

Additionally, the Relay Service Code may also identify authorized users to which the 5G ProSe UE-to-Network Relay would offer service, and may be used to select the related security policies or information e.g. necessary for authentication and authorization between the 5G ProSe Remote UE and the 5G ProSe UE-to-Network Relay (e.g. a Relay Service Code for relays for police members only would be different than a Relay Service Code for relays for Fire Fighters only, even though potentially they provided connectivity to same DN e.g. to support Internet Access).

The message may include an NF identify. The NF identity is used to identify the NF and find the NF consumer.

The message may include a serving network name. The serving network name is used to identify the network.

Step S62: the NF provider checks if the ProSe related subscription data of the UE is updated/available, For example, the ProSe related subscription data of the UE may be associated with whether the 5G ProSe Layer-3 Remote UE access via 5G ProSe Layer-3 UE-to-Network Relay is available, the list of the PLMNs authorized for 5G ProSe services, etc. The NF provider may also check if the service specific parameter is updated, such as checking whether the service parameters for 5G ProSe UE-to-Network Relay Discovery and/or 5G ProSe UE-to-Network Relay Communications (e.g. Relay service code (RSC)) is changed.

Step S63: the NF provider finds the NF consumer based on the NF identity or the routing indicator related to the UE or local policy.

Step S64: the NF provider sends a ProSe subscription notification message to the NF consumer. The notification message includes a UE identity and an indication of ProSe subscription update. For example, the indication of ProSe subscription update may indicate the 5G ProSe Layer-3 Remote UE access via 5G ProSe Layer-3 UE-to-Network Relay is (not) available, the list of the PLMNs authorized for 5G ProSe services, available/unavailable RSC(s).

Step S65: the NF consumer updates the ProSe context.

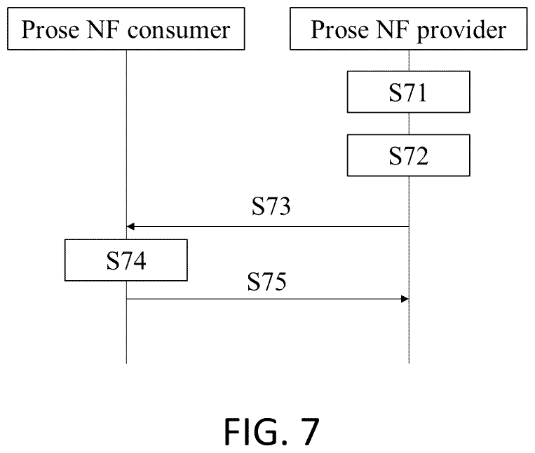

In an embodiment, there is provided an example of the NF provider of ProSe subscription data request the NF consumer of ProSe subscription data to update according to an embodiment of the present disclosure as shown in FIG. 7. The method of FIG. 7 comprises the following steps:

Step S71: the NF provider (e.g. the UDM, the UDR, the PCF, the ProSe AF) checks whether the ProSe related subscription data of the UE is updated. For example, the ProSe related subscription data of the UE may be associated with or indicate whether the 5G ProSe Layer-3 Remote UE access via 5G ProSe Layer-3 UE-to-Network Relay is available, the list of the PLMNs authorized for 5G ProSe services, etc. The NF provider may also check whether at least one of service specific parameters is updated. For instance, the service parameters may be those for the 5G ProSe UE-to-Network Relay Discovery and/or 5G ProSe UE-to-Network Relay Communications (e.g. RSC).

Step S72: the NF provider finds the NF consumer (e.g. the PAnF, the PKMF) based on the local policy or the routing indicator related to the UE.

Step S73: the NF provider sends a ProSe subscription data update request message to the NF consumer. The notification message includes a UE identity and an indication of ProSe subscription update. For example, the indication of the ProSe subscription update may be associated with or indicate whether the 5G ProSe Layer-3 Remote UE access via 5G ProSe Layer-3 UE-to-Network Relay is available, the list of the PLMNs authorized for the 5G ProSe services, available/unavailable RSC.

Step S74: the NF consumer updates the ProSe context.

Step S75: the NF consumer sends a ProSe subscription data update response message to the NF provider.

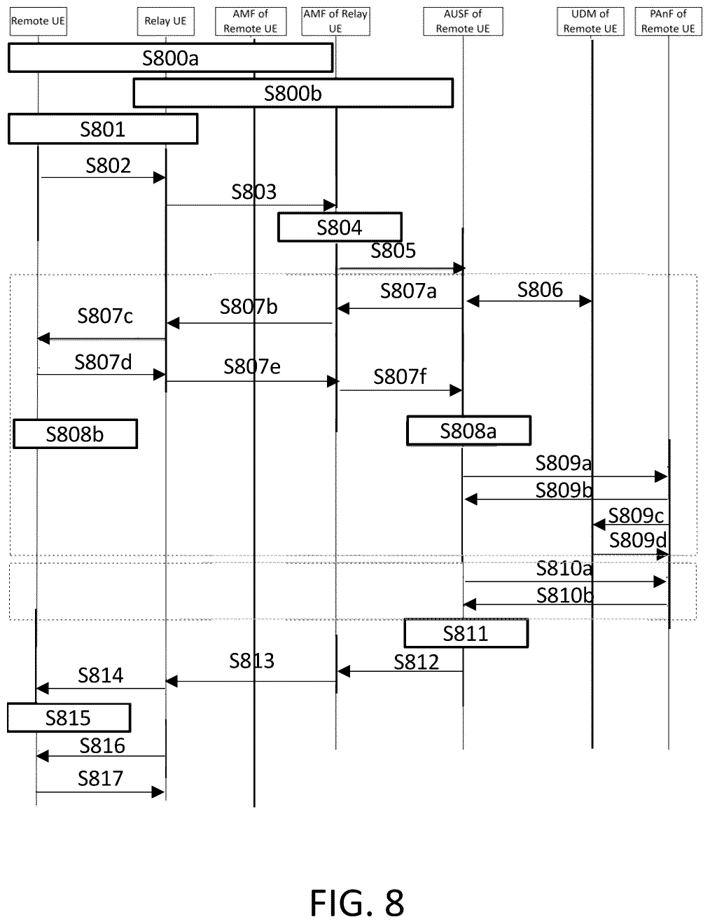

In an embodiment, there is provided an example of a PAnF act as the NF consumer according to an embodiment of the present disclosure as shown in FIG. 8. The method of FIG. 8 comprises the following steps:

Steps S800a+S800b: the 5G ProSe Remote UE and the 5G ProSe UE-to-Network Relay are registered with the network. The 5G ProSe UE-to-Network Relay is authenticated and authorized by the network to provide UE-to-Network Relay service. The 5G ProSe Remote UE is authenticated and authorized by the network to receive UE-to-Network Relay service. PC5 security policies are provisioned to the 5G ProSe Remote UE and the 5G ProSe UE-to-Network Relay respectively during this authorization and information provisioning procedure.

Step S801: the 5G ProSe Remote UE initiates a procedure for Model A 5G ProSe Direct Discovery and/or a procedure for Model B 5G ProSe Direct Discovery. The procedure for Model A 5G ProSe Direct Discovery is applied for open and restricted 5G ProSe Direct Discovery when the ProSe enabled UE is served by the NG-RAN. The procedure for a Model B 5G ProSe Direct Discovery is applied for restricted 5G ProSe Direct Discovery when the ProSe enabled UE is served by the NG-RAN.

Step S802: after the discovery of the 5G ProSe UE-to-Network Relay, the 5G ProSe Remote UE sends a Direct Communication Request to the 5G ProSe UE-to-Network Relay for establishing a secure PC5 unicast link. The 5G ProSe Remote UE includes its security capabilities and PC5 signaling security policy in the DCR message. The message also includes Relay Service Code, Nonce_1.

If the 5G ProSe Remote UE does not have a valid 5G ProSe Remote User Key (5GPRUK), the 5G ProSe Remote UE includes a SUCI in the DCR to trigger 5G ProSe Remote UE specific authentication and establish a 5GPRUK.

If the 5G ProSe Remote UE already has a valid 5GPRUK, the 5G ProSe Remote UE includes the 5GPRUK ID in the DCR to indicate that the 5G ProSe Remote UE wants to get relay connectivity using the 5GPRUK.

Step S803: upon receiving the DCR message, the 5G ProSe UE-to-Network Relay sends the Relay Key Request to the AMF of the 5G ProSe UE-to-Network Relay, including SUCI or 5GPRUK ID, RSC and Nonce_1 received in the DCR message. The 5G ProSe UE-to-Network Relay also includes in the message a transaction identifier that identifies the 5G ProSe Remote UE for the subsequent messages over NAS messages of the 5G ProSe UE-to-Network Relay.

Step S804: the AMF of the 5G ProSe UE-to-Network Relay verifies whether the 5G ProSe UE-to-Network Relay is authorized to provide the UE-to-Network Relay service.

Step S805: the AMF of the 5G ProSe UE-to-Network Relay selects an AUSF based on SUCI or 5GPRUK ID and forwards the parameters received in the Relay Key Request to the AUSF in an Nausf_UEAuthentication_ProseAuthenticate Request message. The Nausf_UEAuthentication_ ProseAuthenticate Request message contains SUCI or 5GPRUK ID of the 5G ProSe Remote UE's, Relay Service Code, and Nonce_1. If the 5GPRUK ID is received from the AMF of the 5G ProSe UE-to-Network Relay, the AUSF of the 5G ProSe Remote UE skips steps S806-S809. If the 5G ProSe Remote UE's SUCI is received from the AMF of the 5G ProSe UE-to-Network Relay, the AUSF of the 5G ProSe Remote UE skips step S810.

Step S806: the AUSF initiates a 5G ProSe Remote UE specific authentication using the ProSe specific parameters received (i.e., RSC, etc.).

The AUSF of the 5G ProSe Remote UE retrieves the Authentication Vectors and the Routing Indicator of the 5G ProSe Remote UE from the UDM via Nudm_UEAuthentication_GetProseAv Request message. Upon reception of the Nudm_UEAuthentication_GetProSeAv Request, the UDM invokes a SIDF de-conceal SUCI to gain SUPI before the UDM can process the request. The UDM checks whether the UE is authorized to use a ProSe UE-to-Network Relay service based on authorization information in the Subscription data of the UE. If the UE is authorized, the UDM chooses the authentication method based on the SUPI.

Step S807a: if EAP-AKA′ is selected by the UDM, the AUSF of the 5G ProSe Remote UE triggers authentication of the 5G ProSe Remote UE based on EAP-AKA′. The AUSF of the 5G ProSe Remote UE generates the EAP-Request/AKA′-Challenge message and sends the EAP-Request/AKA′-Challenge message to the AMF of the 5G ProSe UE-to-Network Relay in a Nausf_UEAuthentication_ProSeAuthenticate Response message.

Step S807b: the AMF of the 5G ProSe UE-to-Network Relay forwards the Relay Authentication Request (including the EAP-Request/AKA′-Challenge) to the 5G ProSe UE-to-Network Relay over a NAS message, including a transaction identifier of the 5G ProSe Remote UE in the message. The NAS message is protected using the NAS security context created for the 5G ProSe UE-to-Network Relay.

Step S807c: based on the transaction identifier, the 5G ProSe UE-to-Network Relay forwards the EAP-Request/AKA′-Challenge to the 5G ProSe Remote UE over PC5 messages.

The USIM in the 5G ProSe Remote UE verifies the validity of the received values by checking whether AUTN can be accepted.

For EAP-AKA′, the USIM computes a response RES. The USIM returns RES, CK, IK to the ME. The ME derives CK′ and IK′.

Step S807d: the 5G ProSe Remote UE returns the EAP-Response/AKA′-Challenge to the 5G ProSe UE-to-Network Relay over PC5 messages.

Step S807e: the 5G ProSe UE-to-Network Relay forwards the EAP-Response/AKA′-Challenge together with the transaction identifier of the 5G ProSe Remote UE to the AMF of the 5G ProSe UE-to-Network Relay in a NAS message Relay Authentication Response.

Step S807f: the AMF of the 5G ProSe UE-to-Network Relay forwards EAP-Response/AKA′-Challenge to the AUSF of the 5G ProSe Remote UE via Nausf_UEAuthentication_ProSeAuthenticate Request.

The AUSF of the 5G ProSe Remote UE performs the UE authentication by verifying the received information.

For EAP-AKA′, the AUSF of the 5G ProSe Remote UE and the 5G ProSe Remote UE may exchange EAP-Request/AKA′-Notification and EAP-Response/AKA′-Notification messages via the AMF of the 5G ProSe UE-to-Network Relay and the 5G ProSe UE-to-Network Relay. After the exchanges, the AUSF of the 5G ProSe Remote UE and the 5G ProSe Remote UE derives the KAUSF_P in the same way as the KAUSF is derived.

Step S808: on successful authentication, the AUSF of the 5G ProSe Remote UE and the 5G ProSe Remote UE generate 5GPRUK and 5GPRUK ID.

The 5GPRUK ID is in NAI format, i.e., username@realm. The username part includes the Routing Indicator from step S806 and the 5GPRUK ID*, and the realm part includes Home Network Identifier.

Step S809a: the AUSF of the 5G ProSe Remote UE selects the PAnF (ProSe Anchor Function) based on a 5GPRUK ID and sends the SUPI, RSC, 5GPRUK and 5GPRUK ID in Npanf_ProseKey_Register Request message to the PAnF. The AUSF may also send the Serving network name to the PAnF.

Step S809b: The PAnF stores the ProSe context info (i.e., SUPI, RSC, 5GPRUK, 5GPRUK ID) for the 5G ProSe Remote UE and sends Npanf_ProseKey_Register Response message to the AUSF. The PAnF requests the subscription information from UDM and/or PCF, and stores it locally.

If a subscribe/notification method is used, the method further comprises Steps S809c and S809d:

Step S809c: the PAnF subscribes to the notification on change of subscription data from UDM and/or PCF. The subscribe message includes the SUPI, RSC and serving network name. The PAnF finds the PCF address from the Binding Support Function or UDR. The PAnF may also request the authorization information of the UE from the UDM and/or the PCF and may store the subscription information locally first.

Step S809d: when there is a subscription change in the list of PLMNs, such as the serving network is not available, or when there is a change of a service specific parameter, such as the Relay service code is not available, the UDM and/or PCF sends a notification message to the PAnF. The notification message includes the SUPI and some subscription data update indications such as the indication of PLMN ID not available, the list of the PLMNs authorized for 5G ProSe services, RSC not available. Then the PAnF updates the ProSe context, such as by: removing the RSC, storing the list of PLMNs, removing the serving network name.

Additionally, if a request/response method is used (not shown in the figure), the method may further comprise: when there is a subscription change in the list of PLMNs, such as the serving network is not available, or when there is a change of service specific parameter, such as the Relay service code is not available, the UDM and/or PCF send a request message to the PAnF. The request message includes the SUPI and some subscription data update indications such as the indication of PLMN ID not available, the list of the PLMNs authorized for 5G ProSe services, RSC not available. Then, the PAnF updates the ProSe context.

Step S810a: the AUSF of the 5G ProSe Remote UE selects the PAnF based on 5GPRUK ID and sends the received 5GPRUK ID and RSC in an Npanf_ProseKey_get Request message.

Step S810b: the PAnF retrieves a 5GPRUK based on the 5GPRUK ID and checks whether the 5G ProSe Remote UE is authorized to use the UE-to-Network Relay service based on a received RSC. If the 5G ProSe Remote UE is authorized and the retrieved 5GPRUK is valid, the PAnF sends the Npanf_ProseKey_get Response message with 5GPRUK to the AUSF. If the authorization is not locally available, the PAnF can request the authorization information from the UDM/PCF. The request message includes the SUPI, RSC. The UDM/PCF checks whether the ProSe Remote UE is authorized to use the UE-to-Network Relay service and sends a response message to PAnF about the authorization result.

Step S811: the AUSF of the 5G ProSe Remote UE generates Nonce_2 and derives the KNR_ProSe key using 5GPRUK, Nonce_1 and Nonce_2.

Step S812: the AUSF of the 5G ProSe Remote UE sends the KNR_ProSe, Nonce_2 in a Nausf_UEAuthentication_ProseAuthenticate Response message to the 5G ProSe UE-to-Network Relay via the AMF of the 5G ProSe UE-to-Network Relay. The EAP Success message is included if step S807 is performed successfully. The AUSF of the 5G ProSe Remote UE also includes the 5GPRUK ID in the message if generated in step S808.

Step S813: when receiving a K_{NR_ProSe} from the AUSF of the 5G ProSe Remote UE via the AMF of the 5G ProSe UE-to-Network Relay, the 5G ProSe UE-to-Network Relay derives PC5 session key K_{relay-sess} and confidentiality key K_{relay-ene} (if applicable) and integrity key K_{relay-int} from K_{NR_ProSe}. K_{NR_ProSe} ID and K_{relay-sess} ID are established in the same way as K_{NRP} ID and K_{NRP-sess} ID. The EAP Success message and 5GPRUK ID are also sent from the AMF of the 5G ProSe UE-to-Network Relay to UE-to-Network Relay if received from AUSF.

Step S814: the 5G ProSe UE-to-Network Relay sends the received Nonce_2 and PC5 signaling security policy of the 5G ProSe Remote UE to the 5G ProSe Remote UE in Direct Security mode command message, which is integrity protected using K_{relay-int}. EAP Success message is included if received from the AMF of the 5G ProSe UE-to-Network Relay.

Step S815: the 5G ProSe Remote UE generates the K_{NR_ProSe} key to be used for remote access via the 5G ProSe UE-to-Network Relay in the same way as defined in step S811. The 5G ProSe Remote UE derives PC5 session key K_{relay-sess} and confidentiality and integrity keys from K_{NR_ProSe} in the same way as defined in step S813.

Step S816: the 5G ProSe Remote UE sends the Direct Security Mode Complete message containing its PC5 user plane security policies to the 5G ProSe UE-to-Network relay, which is protected by K_{relay-int} or/and K_{relay-enc} derived from K_{relay-sess} according to the negotiated PC5 signaling policies between the 5G ProSe Remote UE and the 5G ProSe UE-to-Network Relay.

Step S817: after the successful verification of the Direct Security Mode complete message, the 5G ProSe UE-to-Network Relay responds a Direct Communication Accept message to the 5G ProSe Remote UE to finish the PC5 connection establishment procedures and stores the 5GPRUK ID in the security context associated to the PC5 link with the 5G ProSe Remote UE.

Further communication between the 5G ProSe Remote UE and the Network takes place securely via the 5G ProSe UE-to-Network Relay.

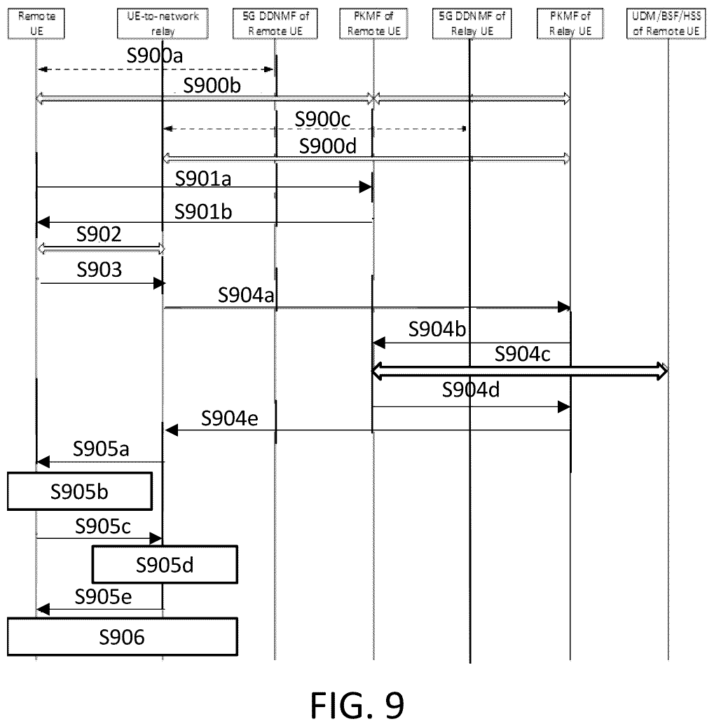

In an embodiment, there is provided an example of a PKMF act as the NF consumer according to an embodiment of the present disclosure as shown in FIG. 9.

The 5G ProSe Remote UE is provisioned with the discovery security materials and ProSe Remote User Key (PRUK) when it is in coverage. These security materials are associated with an expiration time, after which they become invalid. If the UE does not have valid discovery security materials, the 5G ProSe Remote UE needs to connect to the 5G PKMF and to obtain new security materials to use the 5G ProSe UE-to-Network Relay services.

The procedure is described for the scenario that the 5G PKMF of the 5G ProSe Remote UE is different from the 5G PKMF of the 5G ProSe UE-to-Network Relay. If both the 5G ProSe Remote UE and the 5G ProSe UE-to-Network Relay are served by a single 5G PKMF, the 5G PKMF takes the role of the 5G PKMF of the 5G ProSe Remote UE and the 5G PKMF of the 5G ProSe UE-to-Network Relay and the inter-5G PKMF message exchanges are not needed.

In FIG. 9, steps S900a, S900b, S901a, S901b are performed when the 5G ProSe Remote UE is in coverage.

### The Method of FIG. 9 Comprises the Following Steps:

Step S900a: the 5G ProSe Remote UE gets the 5G PKMF address from the 5G DDNMF of its HPLMN. Alternatively, the 5G ProSe Remote UE may be provisioned with the 5G PKMF address by PCF. If the 5G ProSe Remote UE is provisioned with the 5G PKMF address, the 5G ProSe Remote UE may access the 5G PKMF directly without requesting it from the 5G DDNMF. In case that the 5G ProSe Remote UE cannot access the 5G PKMF using the provisioned 5G PKMF address, the 5G ProSe Remote UE may request the 5G PMKF address to the 5G DDNMF.

Step S900b: the 5G ProSe Remote UE establishes a secure connection with the 5G PKMF via PC8 reference point. Security for PC8 interface relies on Ua security if Generic Bootstrapping Architecture (GBA) is used or Ua* security if Authentication and Key Management for Applications (AKMA) is used. The 5G PKMF of the 5G ProSe Remote UE checks whether the 5G ProSe Remote UE is authorized to receive a UE-to-Network Relay service, and if the UE is authorized, the 5G PKMF of the 5G ProSe Remote UE provides the discovery security materials to the 5G ProSe Remote UE. If the 5G ProSe Remote UE provides a list of visited networks, the 5G PKMF of the 5G ProSe Remote UE requests the discovery security materials from the 5G PKMFs of the potential 5G ProSe UE-to-Network Relays from which the 5G ProSe Remote UE gets the relay services. The 5G PKMF of the 5G ProSe UE-to-Network Relay may include the PC5 security policies to the 5G ProSe Remote UE.

In the embodiment, the 5G PKMF may be locally configured with the authorization information of the UE. Otherwise, the 5G PKMF interacts with the UDM of the UE to retrieve the authorization information of the UE.

In the embodiment, the 5G ProSe Remote UE is provisioned by PCF with a list of the potential visited networks for the 5G ProSe UE-to-Network Relay service (which is identified by RSC).

Step S900c: the 5G ProSe UE-to-Network Relay gets the 5G PKMF address from its HPLMN in the same way as described in step S900a.

Step S900d: the 5G ProSe UE-to-Network Relay establishes a secure connection with the 5G PKMF via PC8 reference point as in step S900b. The 5G PKMF of the 5G ProSe UE-to-Network Relay checks whether the 5G ProSe UE-to-Network Relay is authorized to provide 5G ProSe UE-to-Network Relay service, and if the UE is authorized, the 5G PKMF of the 5G ProSe UE-to-Network Relay provides the discovery security materials to the 5G ProSe UE-to-Network Relay. The 5G PKMF of the 5G ProSe UE-to-Network Relay may include the PC5 security policies to the 5G ProSe UE-to-Network Relay.

Step S901a: the 5G ProSe Remote UE sends a PRUK Request message to the 5G PKMF of the 5G ProSe Remote UE. The message indicates that the 5G ProSe Remote UE is requesting a PRUK from the 5G PKMF. If the 5G ProSe Remote UE already has a PRUK from this 5G PKMF, the message also contains the PRUK ID of the PRUK.

The PRUK ID shall take the form of either the NAI format or the 64-bit string. If the PRUK ID is in NAI format, i.e., username@realm, the realm part shall include Home Network Identifier (i.e., HPLMN ID).

Step S901b: the 5G PKMF checks whether the 5G ProSe Remote UE is authorized to receive UE-to-Network Relay services. This is done by using the identity of the 5G ProSe Remote UE associated with the key used to establish the secure connection between the 5G ProSe Remote UE and 5G PKMF in step S900b. If the 5G ProSe Remote UE is authorized to receive the service, the 5G PKMF sends a PRUK and PRUK ID to the 5G ProSe Remote UE. If a PRUK and PRUK ID are included, the 5G ProSe Remote UE stores these and deletes any previously stored ones for this 5G PKMF.

Step S902: the discovery procedure is performed between the 5G ProSe Remote UE and the 5G ProSe UE-to-Network Relay using the discovery parameters and discovery security material.

Step S903: the 5G ProSe Remote UE sends a Direct Communication Request (DCR) that contains the PRUK ID or a SUCI if the Remote UE does not have a valid PRUK, Relay Service Code (RSC) of the 5G ProSe UE-to-Network Relay service and K_{NRP} freshness parameter 1 to the 5G ProSe UE-to-Network Relay. If the PRUK ID is not in NAI format, the DCR message includes the HPLMN ID of the 5G ProSe Remote UE. The PC5 security establishment procedure between the 5G ProSe Remote UE and the 5G ProSe UE-to-Network Relay including security parameters and security policy negotiation and protection of messages hereafter follow the one-to-one security establishment.

Step S904a: the 5G ProSe UE-to-Network Relay sends a Key Request message that contains PRUK ID or SUCI, RSC and K_{NRP} freshness parameter 1 to its 5G PKMF. The Key Request message also includes the HPLMN ID of the 5G ProSe Remote UE if it is included in the DCR.

Step S904b: on receiving the Key Request message, the 5G PKMF of the 5G ProSe UE-to-Network Relay checks if the 5G ProSe UE-to-Network Relay is authorized to provide relay service to the 5G ProSe Remote UE based on the identity of the 5G ProSe UE-to-Network Relay associated with the key used to establish the secure PC8 connection and the received RSC. If the authorization information of the 5G ProSe UE-to-Network Relay is not locally available, the 5G PKMF requests the authorization information from the UDM of the 5G ProSe UE-to-Network Relay (not shown in the figure) using Nudm_SDM_Get service. If the 5G ProSe UE-to-Network Relay is authorized to provide the relay service based on ProSe Subscription data, the 5G PKMF of the 5G ProSe UE-to-Network Relay sends the Key Request with the PRUK ID or the SUCI to the 5G PKMF of the 5G ProSe Remote UE. The 5G PKMF of the 5G ProSe UE-to-Network Relay identifies the 5G PKMF address of the 5G ProSe Remote UE based on the PRUK ID or HPLMN ID or SUCI of the 5G ProSe Remote UE if it is included in the Key Request message.

Step S904c: on receiving the Key Request message from the 5G PKMF of the 5G ProSe UE-to-Network Relay, the 5G PKMF of the 5G ProSe Remote UE checks if the 5G ProSe Remote UE is authorized to use the relay service. The relay service authorization check is based on the PRUK ID and RSC included in the Key Request message or the SUPI of the Remote UE and the RSC included in the Key Request message. If a SUCI is included in the Key Request message, the 5G PKMF of the 5G ProSe Remote UE requests the UDM of the 5G ProSe Remote UE to de-conceal the SUCI to gain the SUPI using Nudm_UEIdentifier_Deconceal service, and the UDM invokes SIDF to de-conceal SUCI to gain SUPI. If the authorization information of the 5G ProSe Remote UE is not locally available, the 5G PKMF requests the authorization information from the UDM of the 5G ProSe Remote UE (not shown in the figure).

In the embodiment, if subscribe/notification method is used, the method may further comprise: the PKMF subscribes to the notification on change of subscription data from UDM and/or PCF. The subscribe message includes the SUPI, RSC. PKMF finds the PCF address from the Binding Support Function or UDR. When there is a subscription change in the list of PLMNs, or when there is a change of service specific parameter, such as the Relay service code is not available, the UDM and/or PCF sends a notification message to the PKMF. The notification message includes the SUPI and some subscription data update indications such as the list of PLMNs, RSC not available. Then the PKMF updates the list of PLMNs and/or RSC.

In the embodiment, if request/response method is used, the method may further comprise: when there is a subscription change in the list of PLMNs, such as some PLMNs are not available, or when there is a change of service specific parameter, such as the Relay service code is not available, the UDM or PCF sends a request message to the PKMF. The request message includes the SUPI and some subscription data update indications such as the list of PLMNs, RSC not available. Then, the PKMF updates the list of PLMNs and/or RSC and sends a response to the UDM or PCF accordingly.

In the embodiment, privacy issues need to be considered while determining whether the SUPI is to be sent to the PKMF. For a privacy control, the UDM can authorize the PKMF based on its NF type or the service provider domain.

In the embodiment, if a new PRUK is required, the 5G PKMF may perform one of the following procedures (as shown in the step S904c in the figure):
If the 5G PKMF of the 5G ProSe Remote UE supports the Zpn interface to the BSF of the 5G ProSe Remote UE, the 5G PKMF of the 5G ProSe Remote UE may request a GBA Push Info (GPI) for the 5G ProSe Remote UE from the BSF. When requesting the GPI, the 5G PKMF shall include a PRUK ID in the P-TID field. On receiving the GPI, the 5G PKMF shall use Ks(_ext)_NAF as the PRUK.
If the 5G PKMF of the 5G ProSe Remote UE supports the SBI interface to the BSF of the 5G ProSe Remote UE, the 5G PKMF may request the GPI via SBI interface. On receiving the GPI, the 5G PKMF shall use Ks(_ext)_NAF as the PRUK.
If the 5G PKMF of the 5G ProSe Remote UE supports the PC4a interface to the HSS of the UE, then the 5G PKMF of 5G ProSe Remote UE may request a GBA Authentication Vector (AV) for the 5G ProSe Remote UE from the HSS. On receiving the AV, the 5G PKMF locally forms the GPI including a PRUK ID in the P-TID field. The 5G PKMF shall use Ks(_ext)_NAF as the PRUK.
If the 5G PKMF of the 5G ProSe Remote UE is co-located or integrated with BSF functionality and supports the SBI interface to the UDM/HSS of the 5G ProSe Remote UE, the 5G PKMF may request the GBA AV via SBI interface. On receiving the AV, the 5G PKMF locally forms the GPI including a PRUK ID in the P-TID field. The 5G PKMF shall use Ks(_ext)_NAF as the PRUK.

In the embodiment, the GPI is supported only when the GBA is used.

Step S904d: the 5G PKMF of the 5G ProSe Remote UE shall generate K_{NRP} freshness parameter 2 and derive K_{NRP} using the PRUK identified by PRUK ID, RSC, K_{NRP} freshness parameter 1 and K_{NRP} freshness parameter 2 as specified in A.8. Then, the 5G PKMF of the 5G ProSe Remote UE sends a Key Response message that contains K_{NRP} and K_{NRP} freshness parameter 2 to the 5G PKMF of the 5G ProSe UE-to-Network Relay. This message shall include GPI if generated. The 5G PKMF of the 5G ProSe Remote UE shall also include the Remote User ID of the 5G ProSe Remote UE in the Key Response message to the 5G ProSe UE-to-Network Relay. PRUK ID is used as a 5G ProSe Remote UE ID in the current document.

Step S904e: the 5G PKMF of the 5G ProSe UE-to-Network Relay sends the Key Response message to the 5G ProSe UE-to-Network Relay, which includes Remote User ID, K_{NRP}, K_{NRP} freshness parameter 2, the PC5 security policies of the relay service, the GPI if used to calculate a fresh PRUK to the UE-to-Network Relay.

Step S905a: the 5G ProSe UE-to-Network Relay derives the session key (K_{NRP-SESS}) from KNRP and then derive the confidentiality key (NRPEK) (if applicable) and integrity key (NRPIK) based on the PC5 security policies. The 5G ProSe UE-to-Network Relay stores the Remote User ID received in step S904d. The 5G ProSe UE-to-Network Relay sends a Direct Security Mode Command message to the 5G ProSe Remote UE. This message also includes the KNRP Freshness Parameter 2 and shall be protected.

Step S905b: if the 5G ProSe Remote UE receives the message containing the GPI, it processes the GPI. The 5G ProSe Remote UE derives the PRUK and obtain the PRUK ID from the GPI.

In the embodiment, the 5G ProSe Remote UE derives KNRP from its PRUK, RSC, KNRP Freshness Parameter 1 and the received KNRP Freshness Parameter 2. Then, it derives the session key (KNRP-SESS) and the confidentiality key (NRPEK) (if applicable), and the integrity key (NRPIK) based on the PC5 security policies in the same manner as the 5G ProSe UE-to-Network Relay and process the Direct Security Mode Command. Successful verification of the Direct Security Mode Command assures the 5G ProSe Remote UE that the 5G ProSe UE-to-Network Relay is authorized to provide the relay service.

In the embodiment, handling of synchronization failure when UE processes the authentication challenge in the GPI may be performed. The 5G ProSe Remote UE shall send Direct Security Mode Failure message and includes RAND and AUTS in the message. The 5G ProSe UE-to-Network Relay sends the key request message to the 5G PKMF of the 5G ProSe Remote UE via the 5G PKMF of the 5G ProSe UE-to-Network Relay upon receiving the Direct Security Mode Failure message from the 5G ProSe Remote UE. The key request message includes the HPLMN ID of the 5G ProSe Remote UE, Relay Service Code and KNRP freshness parameter 1 together with the RAND and the AUTS received from the 5G ProSe Remote UE. If the 5G PKMF of the 5G ProSe Remote UE decides to retry GBA Push procedure, the 5G PKMF of the 5G ProSe Remote UE requests GPI as described in step S904c.

Step S905c: the 5G ProSe Remote UE responds with a Direct Security Mode Complete message to the 5G ProSe UE-to-Network Relay.

Step S905d: on receiving the Direct Security Mode Complete message, the 5G ProSe UE-to-Network Relay verifies the Direct Security Mode Complete message. Successful verification of the Direct Security Mode Complete message assures the 5G ProSe UE-to-Network Relay that the 5G ProSe Remote UE is authorized to get the relay service.

Step S905e: after successful verification, the 5G ProSe UE-to-Network Relay responds a Direct Communication Accept message to the 5G ProSe Remote UE to complete the PC5 connection establishment procedure.

Step S906: the 5G ProSe Remote UE and 5G ProSe UE-to-Network Relay continue the rest of procedure for the relay service over the secure PC5 link such as establishing a new PDU session or modifying an existing PDU session for relaying, if needed etc.

When the 5G ProSe Layer-3 UE-to-Network Relay sends a Remote UE Report to the SMF, the 5G ProSe Layer-3 UE-to-Network Relay shall include Remote User ID received in step S904d.

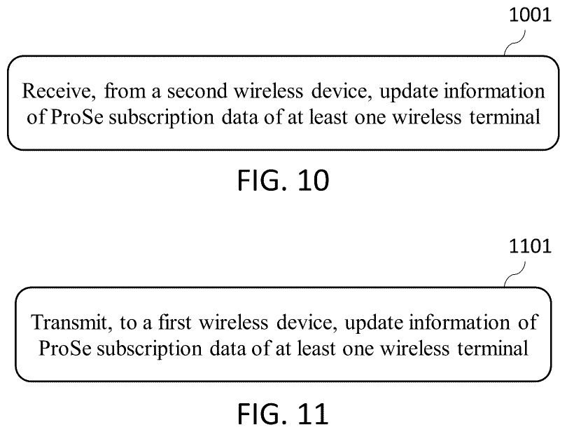

FIG. 10 shows a flowchart of a method according to an embodiment of the present disclosure. The method shown in FIG. 10 may be used in a first wireless device (e.g., ProSe NF (consumer), PAnF, PKMF, a device/apparatus/entity comprising the PAnF and/or PKMF, or a device/apparatus/entity performing at least part of functionalities of the PAnF and/or PKMF) and comprises the following step:

Step 1001: Receive, from a second wireless device, update information of ProSe subscription data of at least one wireless terminal.

In FIG. 10, the first wireless device receives update information of ProSe subscription data/information of at least one wireless terminal (e.g., UE) from a second wireless device. The second wireless device may be a ProSe NF (provider), UDM, UDR, PCF, a device/apparatus/entity comprising at least one of the UDM, UDR and PCF, or a device/apparatus/entity performing at least part of functionalities of the at least one of the UDM, UDR and the PCF. Based on the received update information, the first wireless device updates the ProSe subscription data/information of the at least one wireless terminal. Thus, the first wireless device is able to provide ProSe services to the at least one wireless terminal according to the up-to-date ProSe subscription data.

In an embodiment, the update information comprises at least one of: an identity of each wireless terminal (e.g., SUPI or SUCI), or a ProSe subscription update indication for each wireless terminal. For example, the ProSe subscription update indication indicates at least one of:
whether an access via a relay wireless terminal is available,
a list of PLMNs authorized for ProSe, or
whether a service code associated with a ProSe is available.

In an embodiment, the first wireless device transmits a subscription message for the update information to the second wireless device, to subscribe to (any) update of the ProSe subscription data of the at least one wireless terminal.

In an embodiment, the subscription message comprises at least one of: an identity of each wireless terminal (e.g., SUPI or SUCI), a service code associated with a ProSe (e.g. relay service code), an identity of the first wireless device, or a serving network name.

In an embodiment, the service code indicates at least one of: a connectivity service provided from a wireless terminal to another wireless terminal, or an authorization identification of the ProSe for each wireless terminal. For example, the authorization identification relates to at least one policy of the PorSe for each wireless terminal.

In an embodiment, the first wireless device transmits the subscription message for the update information no earlier than (i.e., when or after) receiving, from an AUSF, a request associated with a ProSe key registration for the at least one wireless terminal, (e.g. step S809a in FIG. 8).

In an embodiment, the first wireless device transmits the subscription message for the update information no earlier than at least one of: transmitting, to the AUSF, a response associated with the ProSe key registration for the at least one wireless terminal, transmitting, to the second wireless device, a request for the ProSe subscription data of at least one wireless terminal, receiving, from the second wireless device, the ProSe subscription data of at least one wireless terminal, or storing the ProSe subscription data of at least one wireless terminal (e.g. step S809b in FIG. 8).

In an embodiment, the first wireless device transmits the subscription message for the update information no earlier than receiving, from the AUSF, a request associated with a ProSe key for the at least one wireless terminal (e.g., step S810a in FIG. 8).

In an embodiment, the first wireless device transmits the subscription message for the update information no earlier than at least one of transmitting, to the AUSF, a response associated with a ProSe key for the at least one wireless terminal, transmitting, to the second wireless device, a request for authorization information of providing a ProSe corresponding to the ProSe key to the at least one wireless terminal, receiving, from the second wireless device, the authorization information of providing the ProSe corresponding to the ProSe key to the at least one wireless terminal, or storing the authorization information of providing the ProSe corresponding to the ProSe key to the at least one wireless terminal (e.g., step S810b in FIG. 8).

In an embodiment, the first wireless device transmits the subscription message for the update information no earlier than at least one of: checking authorization information of providing a ProSe to the at least one wireless terminal, transmitting, to the second wireless device, a request for the authorization information of providing the ProSe to the at least one wireless terminal, or receiving, from the second wireless device, a response for the authorization information of providing the ProSe to the at least one wireless terminal (e.g. step S904c) in FIG. 9.

In an embodiment, the updated information is received in an update request. In this embodiment, the first wireless device transmits a response in response to the update request to the second wireless device.

FIG. 11 shows a flowchart of a method according to an embodiment of the present disclosure. The method shown in FIG. 11 may be used in a second wireless device (e.g. a ProSe NF (provider), UDM, UDR, PCF, a device/apparatus/entity comprising at least one of the UDM, UDR and PCF, or a device/apparatus/entity performing at least part of functionalities of the at least one of the UDM, UDR and the PCF) and comprises the following step:

Step 1101: Transmit, to a first wireless device, update information of ProSe subscription data of at least one wireless terminal.

In this embodiment, the second wireless device transmits update information of ProSe subscription data/information of at least one wireless terminal (e.g., UE) to a first wireless device (e.g., ProSe NF (consumer), PAnF, PKMF, a device/apparatus/entity comprising the PAnF and/or PKMF, or a device/apparatus/entity performing at least part of functionalities of the PAnF and/or PKMF). Specifically, when the ProSe subscription data/information of at least one wireless terminal is changed/updated, the second wireless device transmits the update information associated with the changed/updated ProSe subscription data/information of at least one wireless terminal to the first wireless device. The ProSe subscription data/information is therefore synchronized in a timely manner.

In an embodiment, the update information comprises at least one of: an identity of each wireless terminal (e.g., SUPI or SUCI), or a ProSe subscription update indication for each wireless terminal. For example, the ProSe subscription update indication indicates at least one of:
whether an access via a relay wireless terminal is available,
a list of PLMNs authorized for ProSe, or
whether a service code associated with a ProSe is available.

In an embodiment, the second wireless device receives a subscription message (for subscribing to) the update information from the first wireless device.

In an embodiment, the subscription message comprises at least one of: an identity of each wireless terminal (e.g., SUPI or SUCI), a service code associated with a ProSe (e.g., relay service code), an identity of the first wireless device, or a serving network name.

In an embodiment, the service code indicates at least one of: a connectivity service provided from a wireless terminal to another wireless terminal, or an authorization identification of the ProSe for each wireless terminal. For example, the authorization identification relates to at least one policy of the PorSe for each wireless terminal.

In an embodiment, the second wireless device receives the subscription message for the update information no earlier than (e.g., when or after) receiving, from the first wireless device, a request for the ProSe subscription data of at least one wireless terminal and/or transmitting, to the first wireless device, the ProSe subscription data of at least one wireless terminal (e.g., step S809b in FIG. 8).

In an embodiment, the second wireless device receives the subscription message for the update information no earlier than receiving, from the first wireless device, a request for authorization information of providing a ProSe corresponding to the ProSe key to the at least one wireless terminal and/or transmitting, to the first wireless device, the authorization information of providing the ProSe corresponding to the ProSe key to the at least one wireless terminal (e.g., step S810b in FIG. 8).

In an embodiment, the second wireless device receives the subscription message for the update information no earlier than receiving, from the first wireless device, a request for the authorization information of providing the ProSe to the at least one wireless terminal, and/or transmitting, to the first wireless device, a response for the authorization information of providing the ProSe to the at least one wireless terminal (e.g., step S904c in FIG. 9).

In an embodiment, the second wireless device transmits the update information in an update request. In this embodiment, the second wireless device may further receive a response in response to the update request from the first wireless device.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a first wireless device, the wireless communication method comprising:
receiving, from a second wireless device, update information of proximity service (ProSe) subscription data of at least one wireless terminal.

2. The wireless communication method of claim 1, wherein the update information comprises at least one of:
an identity of each wireless terminal, or
a ProSe subscription update indication for each wireless terminal.

3. The wireless communication method of claim 2, wherein the ProSe subscription update indication indicates at least one of:
whether an access via a relay wireless terminal is available,
a list of public land mobile networks (PLMNs) authorized for ProSe, or
whether a service code associated with a ProSe is available.

4. The wireless communication method of claim 1, further comprising:
transmitting, to the second wireless device, a subscription message for the update information.

5. The wireless communication method of claim 4, wherein the subscription message comprises at least one of:
an identity of each wireless terminal,
a service code associated with a ProSe,
an identity of the first wireless device, or
a serving network name.

6. The wireless communication method of claim 3, wherein the service code indicates at least one of:
a connectivity service provided from a wireless terminal to another wireless terminal, or
an authorization identification of the ProSe for each wireless terminal.

7. The wireless communication method of claim 6, wherein the authorization identification relates to at least one policy of the PorSe for each wireless terminal.

8. The wireless communication method of claim 4, wherein the subscription message for the update information is transmitted no earlier than at least one of:
receiving, from an authentication service function (AUSF), a request associated with a ProSe key registration for the at least one wireless terminal,
transmitting, to the AUSF, a response associated with the ProSe key registration for the at least one wireless terminal,
transmitting, to the second wireless device, a request for the ProSe subscription data of at least one wireless terminal,
receiving, from the second wireless device, the ProSe subscription data of at least one wireless terminal,
storing the ProSe subscription data of at least one wireless terminal,
receiving, from the AUSF, a request associated with a ProSe key for the at least one wireless terminal,
transmitting, to the AUSF, a response associated with a ProSe key for the at least one wireless terminal,
transmitting, to the second wireless device, a request for authorization information of providing a ProSe corresponding to the ProSe key to the at least one wireless terminal,
receiving, from the second wireless device, the authorization information of providing the ProSe corresponding to the ProSe key to the at least one wireless terminal, or
storing the authorization information of providing the ProSe corresponding to the ProSe key to the at least one wireless terminal.

9. The wireless communication method of claim 4, wherein the subscription message for the update information is transmitted no earlier than at least one of:
checking authorization information of providing a ProSe to the at least one wireless terminal,
transmitting, to the second wireless device, a request for the authorization information of providing the ProSe to the at least one wireless terminal, or
receiving, from the second wireless device, a response for the authorization information of providing the ProSe to the at least one wireless terminal.

10. The wireless communication method of claim 1, wherein the updated information is received in an update request.

11. The wireless communication method of claim 10, further comprising:
transmitting, to the second wireless device, a response in response to the update request.

12. The wireless communication method of claim 1, wherein the first wireless device comprises at least one of a ProSe anchor function or a ProSe key management function.

13. The wireless communication method of claim 1, wherein the second wireless device comprises at least one of a unified data management, a unified data repository, a policy control function or a ProSe application function.

14. A wireless communication method for use in a second wireless device, the wireless communication method comprising:
transmitting, to a first wireless device, update information of proximity service, ProSe, subscription data of at least one wireless terminal.

15. The wireless communication method of claim 14, wherein the update information comprises at least one of:
an identity of each wireless terminal, or
a ProSe subscription update indication for each wireless terminal.

16. The wireless communication method of claim 15, wherein the ProSe subscription update indication indicates at least one of:
whether an access via a relay wireless terminal is available,
a list of public land mobile networks (PLMNs) authorized for ProSe, or
whether a service code associated with a ProSe is available.

17. The wireless communication method of claim 14, further comprising:
receiving, from the first wireless device, a subscription message for the update information.

18. The wireless communication method of claim 17, wherein the subscription message comprises at least one of:
an identity of each wireless terminal,
a service code associated with a ProSe,
an identity of the first wireless device, or
a serving network name.

19. A first wireless device, comprising:
a communication unit, configured to receive, from a second wireless device, update information of proximity service (ProSe) subscription data of at least one wireless terminal.

20. A computer program product comprising a computer-readable program medium code stored thereupon, the code, when executed by a processor, causing the processor to implement a wireless communication method recited in claim 1.
